(19) United States
(12) Patent Application Publication
(10) Pub. No.: US 2017/0320496 A1
(43) Pub. Date: Nov. 9, 2017

(54) Method for Operating a Hybrid Vehicle

(71) Applicant: Bayerische Motoren Werke Aktiengesellschaft, Muenchen (DE)

(72) Inventor: Christian LANDERL, Oberneuching (DE)

(21) Appl. No.: 15/656,043

(22) Filed: Jul. 21, 2017

Related U.S. Application Data
(63) Continuation of application No. PCT/EP2016/051623, filed on Jan. 27, 2016.

(30) Foreign Application Priority Data
Mar. 18, 2015 (DE) 10 2015 204 836.5

(51) Int. Cl. B60W 30/18; B60W 10/06; B60W 30/192; B60W 20/40; B60K 6/48; B60W 10/30; B60W 10/08

(52) U.S. Cl. CPC B60W 30/18027; B60W 10/30; B60W 10/06; B60W 10/08; B60W 30/192; B60W 20/40; B60K 6/48; B60K 2006/4808; B60Y 2200/92; Y10S 903/93

(57) ABSTRACT

A method is provided for operating a hybrid vehicle after a stationary state of the hybrid vehicle having an electric machine and an internal combustion engine with a circulating oil lubrication system. The electric machine and the internal combustion engine can be operated independently of one another and their output shafts can be operatively connected to one another via a clutch and/or a transmission for a separate or common drive. The method includes: starting the electric machine and starting the hybrid vehicle with pure electric drive; connecting the drive shafts during the electric drive and cranking the internal combustion engine without inputting fuel until a defined oil pressure is built up in the circulating oil lubrication system; uncoupling the output shafts; continuing to operate the hybrid vehicle with pure electric drive until the internal combustion engine is started. By way of the method, all the components of the internal combustion engine are lubricated with oil at the start and the service life of the internal combustion engine is increased.

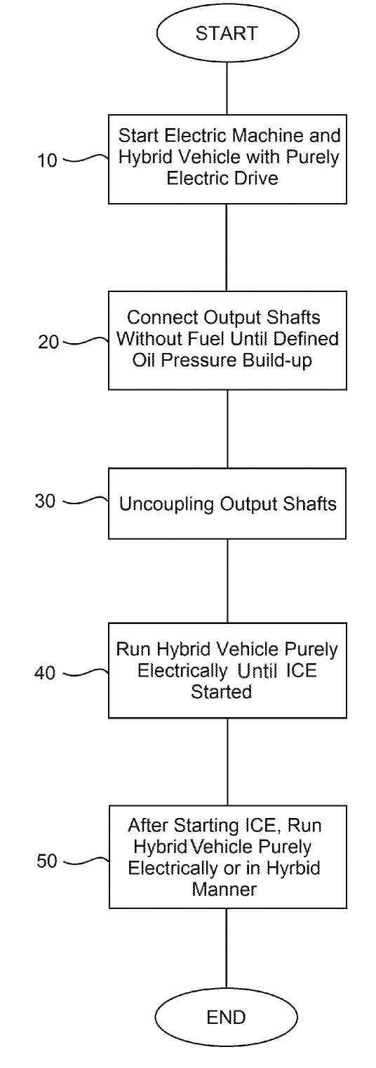

### CROSS REFERENCE TO RELATED APPLICATIONS

This application is a continuation of PCT International Application No. PCT/EP2016/051623, filed Jan. 27, 2016, which claims priority under 35 U.S.C. §119 from German Patent Application No. 10 2015 204 836.5, filed Mar. 18, 2015, the entire disclosures of which are herein expressly incorporated by reference.

### BACKGROUND AND SUMMARY OF THE INVENTION

The invention relates to a method for operating a hybrid vehicle after a standstill of the hybrid vehicle, the hybrid vehicle having an electric machine and an internal combustion engine with a circulating oil lubrication system.

In terms of the technical field, reference is made, for example, to German patent document DE 199 41 705 A1. This document discloses a drivetrain, in particular of a motor vehicle, comprising a drive unit, such as an internal combustion engine, for example, with a drive shaft, and with at least one electric machine, which is used at least as a motor and generator, in operative connection with the drive shaft. The drivetrain is characterized in that the operative connection between the electric machine and the drive shaft has at least two self-adjusting transmission stages which are dependent on an operating mode of the electric machine that is subdivided at least into a starting and operating phase.

A disadvantage of this known prior art is that, after electrically starting the motor vehicle and switching on the internal combustion engine, high rotational speeds occur at possibly rated power directly after the cold start, which causes considerable wear of the tribological components of the internal combustion engine.

Furthermore, German patent document DE 195 48 120 C1 discloses an engine-preheating system for a hybrid vehicle. The hybrid vehicle has an electric motor for driving operation and an internal combustion engine with a generator, which is provided for generating power, and with an accumulator, wherein the internal combustion engine is turned over, unpowered, by the generator in a warm-running phase and the gases heated by a heating device arranged in an intake manifold of the internal combustion engine are fed to the combustion chambers of the internal combustion engine.

A disadvantage of this prior art is the use of the generator for turning over the internal combustion engine, which does not have enough power to generate relatively high rotational speeds of the internal combustion engine.

It is an object of the present invention to provide a measure by which a gentle and low-wear cold start of internal combustion engines, in particular for PHEV vehicles (Plug-in Hybrid Electric Vehicles) can be implemented.

This object is achieved by a method for operating a hybrid vehicle after a standstill of the hybrid vehicle, the hybrid vehicle having an electric machine and an internal combustion engine with a circulating oil lubrication system. The electric machine and the internal combustion engine can be operated independently of one another and the output shafts thereof can be brought into operative connection with one another via a clutch and/or a transmission for a separate or common drive. The method includes the acts of: starting the electric machine and starting the hybrid vehicle with purely electric drive; connecting the output shafts during the electric drive and turning over the internal combustion engine without introducing fuel until a defined oil pressure is built up in the circulating oil lubrication system; uncoupling the output shafts; and continuing to run the hybrid vehicle with purely electric drive until the internal combustion engine is started.

Plug-in hybrid electric vehicles (PHEV vehicles) combine the advantages of battery vehicles and conventionally driven vehicles: over shorter distances and in city traffic, the vehicle runs with the electric drive quietly, locally emission-free and economically with power from an accumulator (such as a battery) which can also be charged via the domestic power supply system, while, by means of the second drive, (for example, a gasoline engine), the vehicle also still runs when the accumulator is discharged and thus a substantially higher range is possible.

In an advantageous manner, the method steps according to the invention include:

(i) starting the electric machine and starting the hybrid vehicle with purely electric drive;

(ii) connecting the output shafts during the electric drive and turning over the internal combustion engine without introducing fuel until a defined oil pressure is built up in the circulating oil lubrication system;

(iii) uncoupling the output shafts;

(iv) continuing to run the hybrid vehicle with purely electric drive until the internal combustion engine is started, wherein the oil lines are filled with oil and all the tribological components of the internal combustion engine are wetted with oil.

Thus, when starting the internal combustion engine, oil pressure is immediately present and sufficient oil for lubrication is already present at or in the lubricating points. The inner friction of the internal combustion engine is thus minimized from the starting of the internal combustion engine and increased wear of the tribological components is counteracted.

There thus occurs a cranking of the internal combustion engine (a turnover by the electric machine) without injection of fuel and without ignition (thus not emission-relevant) after electrically starting the hybrid vehicle.

Advantageous developments of the invention are described herein.

In order, with prolonged running of the hybrid vehicle after starting with purely electric drive, to maintain the oil pressure in the internal combustion engine, there is further proposed a periodic connection of the output shafts during the electric drive and turning over of the internal combustion engine until a defined oil pressure is built-up in the circulating lubrication system.

In other words, periodic turnover (cranking) of the internal combustion engine occurs during electrical running in order to ensure permanent or intermittent lubrication of the tribological components.

After starting the internal combustion engine, it is proposed to continue to run the hybrid vehicle only with the internal combustion engine or with the electric machine and the internal combustion engine. The respective operation occurs in accordance with the power to the hybrid vehicle required by the driver.

Other objects, advantages and novel features of the present invention will become apparent from the following detailed description of one or more preferred embodiments when considered in conjunction with the accompanying drawing.

### BRIEF DESCRIPTION OF THE DRAWING

The single FIGURE is a flow diagram illustrating an exemplary method for operating a hybrid vehicle according to the invention.

### DETAILED DESCRIPTION OF THE DRAWING

The invention relates to a method for operating a hybrid vehicle, in particular a PHEV vehicle (Plug-in Hybrid Electric Vehicle, definition already stated above). What is concerned in particular is a method for operating the hybrid vehicle after a standstill of at least a number of minutes. The hybrid vehicle has at least one electric machine and an internal combustion engine with a circulating oil lubrication system. The electric machine and the internal combustion engine can be operated independently of one another, wherein the output shaft of the electric machine and the output shaft of the internal combustion engine can be brought into operative connection with one another via a clutch and/or a transmission for a separate or common drive of the hybrid vehicle.

Referring to the FIGURE, the method for operating the hybrid vehicle after the standstill has the following method steps:

starting the electric machine and starting the hybrid vehicle with purely electric drive (10);

connecting the output shafts during the electric drive and turning over the internal combustion engine to a rotational speed range between 100 and 1000 [1/min] without introducing fuel and without ignition until a defined oil pressure is built up in a pressure range between 1 and 5 [bar] in the circulating oil lubrication system of the internal combustion engine (20);

uncoupling the drive shafts (30);

continuing to run the hybrid vehicle with purely electric drive until the internal combustion engine is started (40).

By way of the method according to the invention for operating a hybrid vehicle after a standstill, cranking of the internal combustion engine without fuel injection and ignition (thus not emission-relevant) is carried out after the electrical starting. Consequently, in an advantageous manner, the oil lines are filled with oil and all the tribological components of the internal combustion engine are wetted with oil. Thus, when starting the internal combustion engine, oil pressure is immediately present and sufficient oil for the lubrication is already present at or in the lubricating points. The inner friction of the internal combustion engine is thus minimized from the starting of the internal combustion engine and increased wear of the tribological components is counteracted.

In the event that, for example, the hybrid vehicle is run in purely electric operation for a prolonged period after starting, there is further proposed the periodic connection of the output shafts during the purely electric drive and the turnover of the internal combustion engine in a time range from 0.5 to 10 [s] until a defined oil pressure is built up in the circulating oil lubrication system. As just stated, the turnover operations can lie within a time range from a number of tenths of a second to a number of seconds. Thus, with purely electric operation, a situation is prevented in which the oil pressure gradually reduces over time in the internal combustion engine and the internal combustion engine is started without oil pressure, which can lead to wear problems.

Furthermore, when the internal combustion engine is turned over by the electric machine, a turnover torque compensation can be implemented so that the driver of the hybrid vehicle does not perceive the turnover periods and the driving comfort would not be compromised.

In a further step, after starting the internal combustion engine, the hybrid vehicle can continue to be run either only with the internal combustion engine or with the electric machine and the internal combustion engine. This occurs depending on the power required by the driver of the hybrid vehicle (50).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a hybrid vehicle after a standstill of the hybrid vehicle, the hybrid vehicle having an electric machine and an internal combustion engine with a circulating oil lubrication system, the electric machine and the internal combustion engine being operable independently of one another and output shafts thereof are coupleable with one another via a clutch and/or a transmission for providing a separate or common drive, the method comprising the acts of:
starting the electric machine and starting the hybrid vehicle with purely electric drive;
connecting the output shafts during the purely electric drive and turning over the internal combustion engine without introducing fuel until a defined oil pressure is built-up in the circulating oil lubrication system;
uncoupling the output shafts; and
continuing to run the hybrid vehicle with the purely electric drive until the internal combustion engine is started.

2. The method according to claim 1, further comprising the act of:
in an extending running of the hybrid vehicle after starting with the purely electric drive, periodically connecting the output shafts during the purely electric drive and turning over the internal combustion engine until the defined oil pressure is built-up in the circulating oil lubrication system.

3. The method according to claim 2, further comprising the act of:
after starting the internal combustion engine, continuing to run the hybrid vehicle only with the internal combustion engine or with both the electric machine and the internal combustion engine.

4. The method according to claim 1, further comprising the act of:
after starting the internal combustion engine, continuing to run the hybrid vehicle only with the internal combustion engine or with both the electric machine and the internal combustion engine.
